(19) United States
(12) Patent Application Publication
(10) Pub. No.: US 2019/0145451 A1
(43) Pub. Date: May 16, 2019

(54) FIXING ELEMENT

(71) Applicant: fischerwerke GmbH & Co. KG, Waldachtal (DE)

(72) Inventors: Martin LINKA, Horb a.N. (DE); Raphael DIXA, Waldachtal (DE)

(21) Appl. No.: 16/308,725

(22) PCT Filed: Jun. 20, 2017
(86) PCT No.: PCT/EP2017/065008

§ 371 Date: Dec. 10, 2018

(30) Foreign Application Priority Data
Jun. 29, 2016 (DE) 10 2016 111 906.7

(51) Int. Cl. F16B 13/06

(52) U.S. Cl. CPC F16B 13/065

(57) ABSTRACT

A fixing element is provided for anchoring in a drilled hole. The fixing element extends along a longitudinal axis and has a shank on which an expansion sleeve is arranged. On the shank there is also arranged a holding element by which the expansion sleeve is connected by frictional engagement to the shank so as to be fixed against relative rotation.

The invention relates to a fixing element having the features of the preamble of claim 1.

German Offenlegungsschrift DE 37 07 510 A1 discloses a fixing element which is anchorable in a drilled hole by expansion of an expansion sleeve. For expanding the expansion sleeve the fixing element has a conical nut as expander body, so that the conical nut can be drawn into the expansion sleeve by screwing in a screw and the expansion sleeve can thereby be expanded. On the shank of that fixing element there is arranged a resilient ring as holding element which holds the expansion sleeve in an intended position in the drilled hole. Also arranged on the shank of that fixing element is a sleeve having longitudinal ribs as anti-corotation means for the expansion sleeve, which prevents the expansion sleeve from corotation during expansion in the drilled hole.

The problem of the invention is to propose an alternative fixing element.

That problem is solved according to the invention by a fixing element having the features of claim 1. The fixing element according to the invention for anchoring in a drilled hole extends along a longitudinal axis which is parallel to or identical with the introduction direction of the fixing element in which the fixing element is intended to be introduced into a drilled hole. The fixing element has a shank extending in the longitudinal direction, which shank has load-application means, a neck portion and an expander body. The load-application means is especially implemented in the form of an external thread onto which a nut can be screwed for securing a mounted component. Alternatively the load-application means can also be in the form of an internal thread or a kind of bayonet closure, this list not being exhaustive. The expander body serves for expanding an expansion sleeve which is arranged on the neck portion. The expander body is especially arranged at the end of the fixing element that is at the front in the introduction direction and is especially configured in such a way that the diameter of a circle circumscribing the expander body increases in the introduction direction towards the front end of the expander body. The expander body especially has a conical or frustoconical shape. The neck portion is a portion on the shank of the fixing element that has a smaller external diameter than the expander body at its cross-section of largest diameter. The expansion sleeve is especially arranged so as to be axially movable on the neck portion and especially fully encompasses the neck portion in the circumferential direction or at least encompasses more than half of its circumference. By drawing the expander body into the expansion sleeve, the expansion sleeve can be expanded radially, that is to say enlarged in diameter in a radial plane relative to the longitudinal axis, so that in a drilled hole it can be moved towards the wall of the drilled hole and clamped against the wall of the drilled hole by frictional and/or interlocking engagement. In particular, for expansion the expander body is moved along the longitudinal axis towards the expansion sleeve, especially in a direction opposite to the introduction direction. In order to hold the expansion sleeve in a specific position in the drilled hole while the expander body is being drawn into the expansion sleeve, a holding element is arranged on the shank of the fixing element, especially between the expansion sleeve and the load-application means. The holding element has an opening in which the shank is accommodated, especially the neck portion of the shank. To modify its diameter the holding element is resiliently deformable, that is to say it is reversibly modifiable in diameter. The diameter can especially be made smaller by radial pressure and made larger again by relaxation of the pressure. Accordingly, by virtue of its resilient deformability in a radial and/or circumferential direction, the holding element can be adapted to the actual diameter of a drilled hole into which the fixing element is being inserted. As a result, in particular the fixing element is secured against falling out in the case of overhead mounting.

According to the invention the holding element is compressible by radial pressure in such a way that the external diameter of the holding element is larger than the external diameter of the unexpanded expansion sleeve and the internal diameter of the holding element is the same as the diameter of the part of the shank on which the holding element is arranged, in such a way that the holding element is connected by frictional engagement to the shank so as to be fixed against relative rotation. In particular, the holding element is arranged on the neck portion and, by virtue of the friction acting between the shank and the holding element, the holding element is held on the shank so as to be fixed against relative rotation. An axial movement of the holding element relative to the shank is still possible, however, if the friction is overcome. “Compressible” means here especially compressible in a radial and/or circumferential direction. The external diameter of the holding element is especially larger than the diameter, especially larger than the nominal diameter, of a drilled hole into which the fixing element is designed to be introduced, so that the wall of the drilled hole exerts radial pressure on the holding element on insertion of the fixing element into the drilled hole. The holding element is accordingly in contact with the wall of the drilled hole, especially in such a way that, by virtue of the friction arising between the holding element and the wall of the drilled hole, it is held in the drilled hole so as to be fixed against relative rotation. The expansion sleeve, however, need not be in contact with the wall of the drilled hole. On the contrary, the external diameter of the expansion sleeve is preferably chosen so that in the unexpanded state it is smaller than the nominal diameter of the fixing element, that is to say, for example, 9.8 mm in the case of a fixing element of nominal diameter 10 mm that is designed to be introduced into a 10 mm drilled hole, so that the fixing element can be inserted without difficulty, and especially without the fixing element being struck with a hammer on its end that is at the rear in the introduction direction, into a drilled hole created with the designated nominal diameter. As a result of the radial pressure exerted on the holding element by the wall of the drilled hole, according to the invention the shank is also connected to the holding element so as to be fixed against relative rotation. Although, after being compressed, the external diameter of the holding element is still larger than the external diameter of the expansion sleeve, its inner side is already in contact with the shank. Accordingly, after insertion into a drilled hole the fixing element is held in the drilled hole so as to be fixed against relative rotation. In particular, because the holding element and the shank are connected so as to be fixed against relative rotation, the resulting holding moment is greater than the moment for application of a load-transfer means to the load-application means. The load-transfer means is especially a nut if the load-application means is an external thread and especially a screw if the load-application means is an internal thread. Corotation of the fixing element, such as could occur, for example, when a nut is screwed onto load-application means in the form of an external thread, is accordingly effectively prevented by the configuration of the fixing element according to the invention. In addition, the fixing element according to the invention is distinguished by a simple and economically producible structure and it can be introduced into a drilled hole without a large amount of force.

Preferably the holding element has an annular or sleeve-like wall having at least one weakened position. The weakened position serves for increasing the deformability of the wall in a radial and/or circumferential direction. “Weakened position” is to be understood herein as being especially a groove, a slot or a spring-like element which, by virtue of its shaping, facilitates resilient modification of the external and/or internal diameter of the wall. It is also possible for a plurality of slots to be provided, for example in the introduction direction and in a direction opposite to the introduction direction and spaced apart from one another in the circumferential direction. The weakened position especially completely severs the wall, especially in the form of a slot in the axial direction, with the result that end faces directed towards one another are formed on the wall on either side of the slot, which end faces are spaced apart from one another in the circumferential direction. For mounting on the shank of the fixing element, a resilient ring so configured can simply be pushed on by a radial movement and is also resiliently deformable by radial pressure.

In a further preferred embodiment of the fixing element according to the invention, the shank is in one piece, that is to say the load-application means, the neck portion and the expander body have been produced from one piece, for example from a piece of steel wire by cold mass forming, as is customary in the case of bolt anchors. This allows the fixing element to be produced economically and to have a simple structure with a small number of parts.

Furthermore, it is preferred that at least one connecting element be arranged on the holding element for connection to the expansion sleeve. The connecting element especially extends in a longitudinal direction towards the expansion sleeve and connects the holding element to the expansion sleeve especially so as to be fixed against relative rotation and/or axially fixed. As a result of that configuration, once the fixing element has been introduced as intended into a drilled hole, the expansion sleeve is connected via the holding element to the shank of the fixing element so as to be fixed against relative rotation and/or axially fixed. In the case of an axially fixed connection, the connection can optionally be separated again during expansion. In addition, the expansion sleeve can be connected to the connecting element in such a way that the connecting element holds the expansion sleeve on the shank of the fixing element. This is particularly advantageous when the expansion sleeve is not one-piece but consists of a plurality of expansion shells.

In a further preferred embodiment of the fixing element according to the invention, radially outwardly extending projections are arranged on the holding element. Such radially extending projections can be resiliently deformable in a radial direction in such a way that they determine the compressibility of the holding element. In particular, the radially outwardly extending projections are arranged on an annular or sleeve-like wall of the holding element so as to be resiliently flexible. The compressibility is in this case provided by the projections, while the wall can be implemented so as to be stable and only slightly deformable. The projections are preferably movable into receiving spaces in the wall of the holding element so that, by resilient engagement of the projections in the receiving spaces, the diameter of the holding element can also be adapted to a drilled hole having a diameter which lies in the lower tolerance range of the designated permissible diameter for the fixing element.

An especially readily expansible embodiment of the fixing element according to the invention has an expansion sleeve consisting of a plurality of individual expansion shells which are not integrally connected to one another. The individual expansion shells can be arranged on the shank of the fixing element by way of the connecting element and held on the shank by the connecting element.

Preferably the expansion sleeve is surrounded by an annular spring which at least partly encompasses the expansion sleeve and especially holds expansion shells of the expansion sleeve together. The expansion shells can be integrally connected to one another or arranged as individual parts on the shank. The annular spring consists especially of metal, rubber or plastics and can be slotted. It need not enclose the expansion sleeve around the entire circumference. The annular spring prevents the expansion sleeve from expanding unintentionally. If the expansion shell consists of individual expansion shells that are not integrally connected to one another, the annular spring holds the expansion shells on the shank.

Preferably the annular spring is located in a groove which is formed in the circumferential direction on the expansion sleeve. This ensures a good connection between the annular spring and the expansion sleeve. In addition, in this case the diameter of the fixing element in the region of the expansion sleeve is not increased, or is increased only insignificantly, by the annular spring, because the annular spring is able to lie in the groove in such a way that it does not protrude, or protrudes only negligibly, above the expansion sleeve in a radial direction.

The groove is preferably formed on the expansion shells, especially in a region of the expansion shells that has a reduced width in the circumferential direction. The production of the groove on expansion shells, especially in the region of reduced width, is easily effected by stamping and requires relatively low forces, especially in the region of reduced width.

Preferably the connecting element is connected to the annular spring. This provides the fixing element with an economical structure that is simple to produce, because the connecting element with the annular spring can especially be implemented in one piece.

As a result of the described construction, the introduction of the fixing element according to the invention into a drilled hole created with the designated nominal diameter can be effected without a large amount of force, especially without it being necessary for the fixing element to be driven into a drilled hole with a hammer, which here means it can especially be pushed or inserted into the drilled hole manually by a user. It is therefore unnecessary to provide the fixing element according to the invention with a hammer-in pin at the end of the shank that is at the rear in the introduction direction, as is currently customary for bolt anchors. According to the invention, a load-application means in the form of an external thread can accordingly extend as far as the end of the fixing element that is at the rear in the introduction direction, because there is no risk, or only a very small risk, of the external thread being damaged by hammer blows during introduction of the fixing element into the drilled hole.

The invention is explained in greater detail below with reference to two exemplary embodiments which are shown in the Figures, wherein

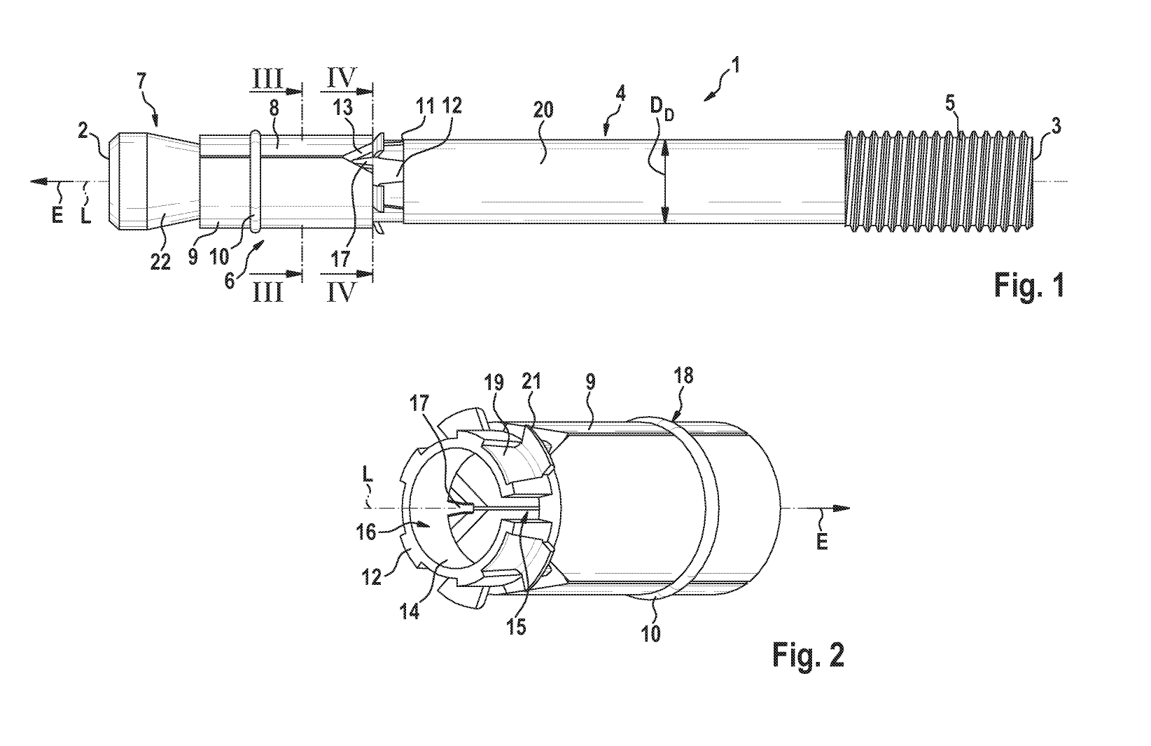

FIG. 1 is a side view of a first fixing element according to the invention;

FIG. 2 is a perspective view of the expansion sleeve and the holding element of the fixing element of FIG. 1;

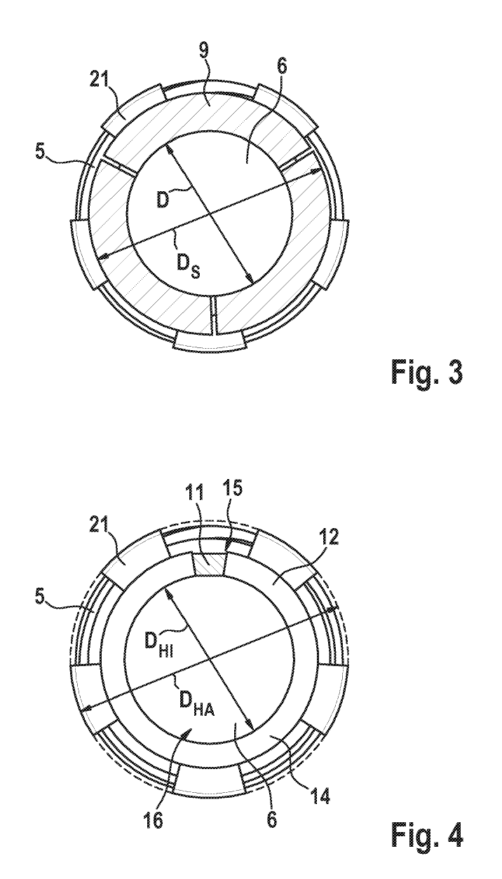

FIG. 3 shows a section through the fixing element in the plane III-III;

FIG. 4 shows a section through the fixing element in the plane IV-IV;

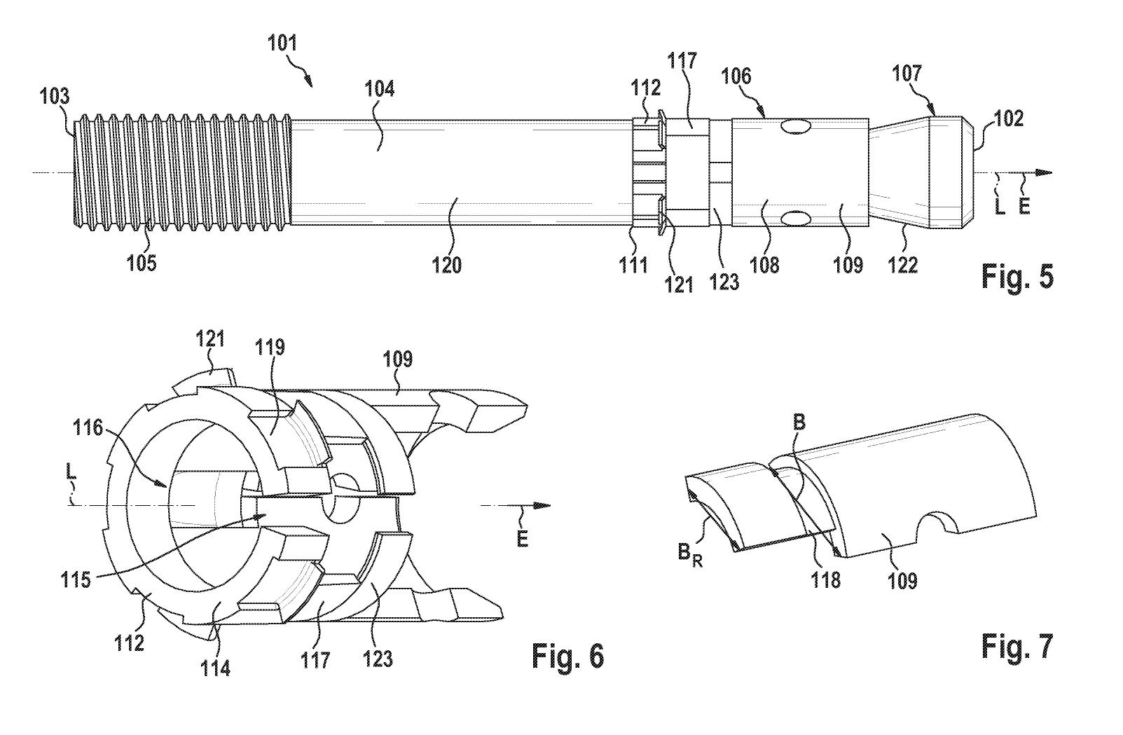

FIG. 5 is a side view of the second fixing element according to the invention;

FIG. 6 is a perspective view of the expansion sleeve and the holding element of the fixing element of FIG. 3; and

FIG. 7 is a perspective view of an expansion shell of the expansion sleeve of the second fixing element according to the invention.

FIGS. 1 to 4 show a first fixing element 1 according to the invention for anchoring in a drilled hole (not shown). The fixing element 1 extends along a longitudinal axis L from an end 2, which is at the front in the introduction direction E, to a rear end 3 of the fixing element 1. The fixing element 1 is implemented as a bolt anchor having an elongated, peg-like shank 4 of one-piece construction. Starting from the rear end 3, an external thread 5 is provided on the shank 4 as load-application means, which external thread is adjoined in the introduction direction E by a cylindrical spacer portion 20. The external thread 5 extends as far as the rear end 3 of the fixing element 1. In front of the spacer portion 20 in the introduction direction E there is arranged a neck portion 6 which is likewise cylindrical with a diameter D which is, however, smaller than the diameter DD of the spacer portion 20. The neck portion 6 is adjoined in the introduction direction E by an expander body 7, forming the front portion of the shank 4, which has a conical expansion portion 22 which widens in diameter in the introduction direction E.

On the neck portion 6 there is arranged an expansion sleeve 8 consisting of three individual expansion shells 9 which are curved in the circumferential direction and in cross-section form parts of a circular ring, as can be seen in FIG. 3. The expansion shells 9 are not connected to one another, especially not integrally. At the rear ends of their longitudinal edges the expansion shells 9 are chamfered, so that there are triangular recesses 13 between the expansion shells. The three expansion shells 9 are held on the neck portion 6 of the shank 4 by a rubber ring 10 acting as annular spring 23, which rubber ring is located in a groove 18. The expansion shells 9 are held against the neck portion 6 by the rubber ring 10 in such a way that their inner sides are in surface-to-surface contact with the neck portion 6 (see FIG. 3). A holding element 12 is arranged between the expansion sleeve 8 and the transition from the neck portion 6 to the spacer portion 20, which transition is in the form of an annular step 11.

The holding element 12 has a sleeve-like wall 14 having an axial slot 15 as weakened position. As a result of the slot 15, the wall 14 forms an open circular ring having an opening 16 for receiving the neck portion 6 of the shank 4, as can be seen in FIG. 4. At its rear end in the introduction direction E, the holding element 12 is formed so as to lie flat against the annular step 11. At its front end, three pin-like connecting elements 17 are formed as projections 21 on the wall 14, which projections are uniformly distributed around the circumference of the wall 14 and engage in the triangular recesses 13 of the expansion sleeve 8 and connect the expansion sleeve 8 to the holding element 12 so as to be fixed against relative rotation. In the outer surface of the wall 14 there are formed rectangular receiving spaces 19, at the front ends of which there are arranged radially outwardly extending projections 21. The projections 21 are formed integrally with the wall 14 from plastics and are resiliently connected to the wall 14. The projections 21 extend radially outwards in such a way that they define the external diameter D_{HA} of the holding element 12 (see FIG. 4).

The expansion shells 9 form the expansion sleeve 8 which, in an unexpanded state, has an external diameter D_{S} that is smaller than the nominal diameter of the fixing element 1. The nominal diameter of the fixing element 1 is the same as the nominal diameter of the drill to be used to drill the hole into which the fixing element 1 is to be introduced. For example, for a 10 mm drilled hole a 10 mm drill is used and the nominal diameter of the fixing element 1 is 10 mm, even though the actual diameter of the fixing element 1 may differ therefrom. In the case of the fixing element 1 according to the invention, the external diameter D_{S} of the expansion sleeve 8 is smaller than the nominal diameter of the fixing element 1 and is 9.8 mm. The holding element 14, however, as a result of the projections 21, has an external diameter D_{HA} that is larger than the nominal diameter. That external diameter D_{HA} is defined by the projections 21 and is accordingly modifiable by resilient deformation.

When the fixing element 1 is inserted as intended into a drilled hole of a nominal diameter, the expansion sleeve 8 does not impede insertion, so that the fixing element 1 can be pushed or inserted into the drilled hole without a large amount of force, especially without using a hammer. During insertion, the radially outwardly extending projections 21 fold at least to some extent resiliently into the receiving space 19. The projections 21 rest with their radially outer, free ends in contact with the wall of the drilled hole and are pressed resiliently against the wall of the drilled hole in such a way that the wall of the drilled hole compresses the holding element 12 radially so that the slot 15 closes slightly and the internal diameter D_{HI} of the holding element 12 corresponds to the diameter D of the neck portion 6. The external diameter D_{HA} of the holding element 12 is accordingly larger than the external diameter D_{S} of the unexpanded expansion sleeve 8 and the internal diameter D_{HI} of the holding element 12 is the same as the diameter D of the neck portion 6. As a result of the radial pressure exerted on the holding element 12 by the wall of the drilled hole, the holding element 12 rests closely against the neck portion 6 so that, by virtue of the friction between the holding element 12 and the neck portion 6, the holding element 12 is connected by frictional engagement to the shank 4 so as to be fixed against relative rotation. The frictional action impedes displacement of the shank 4 in the axial direction relative to the holding element 12 and to the expansion sleeve 8 only negligibly and can be overcome by tightening a nut (not shown) screwed onto the external thread 5. However, the friction acting between the nut and the external thread 5 when the nut is screwed on is insufficient to overcome the friction of the connection that that fixes the neck portion 6 and the holding element 12 against relative rotation and so the shank 4 would corotate with the nut. Because the shank 4 is connected to the holding element 12 so as to be fixed against relative rotation, the shank 4 is prevented from corotation when a nut is screwed onto the external thread 5. When the nut is tightened, the shank 4 is moved out of the drilled hole in a direction opposite to the introduction direction E. As a result of the holding element 12, which is resiliently clamped by its projections 21 against the wall of the drilled hole, the expansion sleeve 8 remains in fixed position in the drilled hole and the expander body 7 with its conical expansion portion 22 is drawn into the expansion sleeve 8, with the result that the expansion shells 9 are expanded radially. The friction between the holding element 12 and the shank 4 is overcome by the force acting in the axial direction, whereas the force acting in the circumferential direction as a result of screwing on the nut is insufficient to cancel the connection that fixes the holding element 12 and the shank 4 against relative rotation.

FIGS. 5 to 7 show a second fixing element 101 according to the invention, the shank 104 of which is constructed in the same way as the shank 4 of the fixing element 1 of FIGS. 1 to 4. To avoid repetitions, only the differences from the fixing element 1 of FIGS. 1 to 4 will be discussed below. The fixing element 101 likewise has a holding element 112, the structure of which corresponds to that of the holding element 12 of the first fixing element 1 according to the invention. However, the projections 121 acting as connecting elements 117, which projections are arranged on the introduction-side front end of the wall 114, are integral with a slotted annular spring 123 running in the circumferential direction, which spring engages in grooves 118 of the expansion shells 109. In this case the expansion shells 109 are connected to the holding element 112 so as to be both fixed against relative rotation and axially fixed. The grooves 118 are formed in a rear region of the expansion shell 109, which region has a width BR, measured in the circumferential direction, that is reduced relative to the width B of the region of the expansion shell 109 that is at the front in the introduction direction E, with the result that the groove 118 can be stamped into the material more easily than in the front region of the expansion shell 109.

By virtue of their configuration according to the invention, the fixing elements 1, 101 according to the invention shown in the Figures can be introduced into a drilled hole using very little axial force. A particular advantage is that it is usually unnecessary to use a hammer to drive the fixing elements 1, 101 into a drilled hole. The fixing elements 1, 101 are of simple construction and consist of relatively few, easily assembled parts and they are therefore economical to produce.

### LIST OF REFERENCE SIGNS

### Fixing Element

1, 101 fixing element
2, 102 front end of the fixing element 1, 101
3, 103 rear end of the fixing element 1, 101
4, 104 shank
5, 105 external thread
6, 106 neck portion
7, 107 expander body
8, 108 expansion sleeve
9, 109 expansion shell
10 rubber ring
11, 111 annular step
12, 112 holding element
13 triangular recess
14, 114 wall
15, 115 slot
16, 116 opening
17, 117 connecting element
18, 118 groove
19, 119 receiving space
20, 120 spacer portion
21, 121 projection
22, 122 conical expansion portion
23, 123 annular spring
B width of an expansion shell 9, 109
B_{R} reduced width of an expansion shell 109
D diameter of the neck portion 6
D_{D} diameter of the spacer portion 20
D_{HA} external diameter of the holding element 12
D_{HI} internal diameter of the holding element 12
D_{S} external diameter of the unexpanded expansion sleeve 8
E introduction direction
L longitudinal axis

1. A fixing element for anchoring in a drilled hole, wherein the fixing element extends along a longitudinal axis and has a shank having a load-application means, a neck portion and an expander bod, wherein on the neck portion there is arranged an expansion sleeve which is expansible radially by drawing the expander body into the expansion sleeve, and wherein on the shank there is arranged a holding element which is resiliently deformable to modify its diameter and which has an opening in which the shank is accommodated,
wherein
the holding element is compressible by radial pressure in a way that the external diameter of the holding element is larger than the external diameter of the unexpanded expansion sleeve and the internal diameter of the holding element is the same as the diameter of the part of the shank on which the holding element is arranged, in a way that the holding element is connected by frictional engagement to the shank so as to be fixed against relative rotation.

2. The fixing element according to claim 1, wherein the holding element has an annular or sleeve-like wall having at least one weakened position.

3. The fixing element according to claim 1, wherein the shank is in one piece.

4. The fixing element according to claim 1, wherein on the holding element there is arranged at least one connecting element for connection to the expansion sleeve.

5. The fixing element according to claim 1, wherein radially outwardly extending projections are arranged on the holding element.

6. The fixing element according to claim 2, wherein the projections are movable resiliently into receiving spaces in the wall of the holding element.

7. The fixing element according to claim 1, wherein the expansion sleeve comprises a plurality of individual expansion shells which are not integrally connected to one another.

8. The fixing element according to claim 1, wherein the expansion sleeve is surrounded by an annular spring.

9. The fixing element according to claim 8, wherein the annular spring is located in a groove which is formed in the circumferential direction on the expansion sleeve.

10. The fixing element according to claim 7, wherein the expansion sleeve is surrounded by an annular spring, the annular spring is located in a groove which is formed in the circumferential direction on the expansion sleeve, and the groove is formed on the expansion shells in a region of the expansion shells that has a reduced width in the circumferential direction.

11. The fixing element according to claim 4, wherein the expansion sleeve is surrounded by an annular spring and the connecting element is connected to the annular spring.

12. The fixing element according to claim 1, wherein the load-application means is an external thread which extends as far as the end of the fixing element that is at the rear in the introduction direction.

13. The fixing element according to claim 1, wherein the expansion sleeve in the unexpanded state has an external diameter that is smaller than the nominal diameter of the fixing element.
